(19) United States
(12) Patent Application Publication
(10) Pub. No.: US 2010/0097891 A1
(43) Pub. Date: Apr. 22, 2010

(54) AUTO TUNE SONAR SYSTEM

(75) Inventor: Duane E. Cummings, Monticello, MN (US)

Correspondence Address: NIKOLAI & MERSEREAU, P.A., 900 SECOND AVENUE SOUTH, SUITE 820, MINNEAPOLIS, MN, 55402, US

(73) Assignee: NATURE VISION INC., Brainerd, MN (US)

(21) Appl. No.: 12/256,179

(22) Filed: Oct. 22, 2008

(51) Int. Cl. G01S 15/89

(52) U.S. Cl. 367/88

(57) ABSTRACT

In some embodiments, a sonar system may include one or more of the following features: (a) a microcontroller electronically coupled to a receiver, (b) a transmitter electronically coupled to the microcontroller and the receiver, (c) a transducer electronically coupled the transmitter and the receiver, the transmit frequency of the transmitter being auto tuned to a best echo frequency of the transducer, (d) a display electronically coupled to the microcontroller, and (e) a keyboard electronically coupled to the microcontroller.

### BACKGROUND OF THE INVENTION

I. Field of the Invention

Embodiments of the present invention relate to sonar equipment. Particularly, embodiments of the present invention relate to the tuning of sonar transducers. More particularly, embodiments of the present invention relate to automatic tuning of a sonar transmitter and receiver to a transducer.

II. Discussion of Related Art

A fishfinder is a type of fathometer, both being specialized types of echo sounding systems, a type of Active SONAR. (‘Sounding’ is the measurement of water depth, a historical nautical term of very long usage.) The fishfinder uses active sonar to detect fish and ‘the bottom’ and displays them on a graphical display device, generally a LCD or CRT screen. In contrast, the modern fathometer (from fathom plus meter, as in ‘to measure’) is designed specifically to show depth, so it may use only a digital display (useless for fish finding) instead of a graphical display, and frequently will have some means of making a permanent recording of soundings (which are merely shown and subsequently electronically discarded in common sporting fishfinder technology) and are always principally instruments of navigation and safety. The distinction is in their main purpose and hence in the features given the system. Both work the same way, and use similar frequencies, and, display type permitting, both can show fish and the bottom. Thus today, both have merged, especially with the advent of computer interfaced multipurpose fishfinders combining GPS technology, digital chart-plotting, perhaps radar and electronic compass displays in the same affordable sporting unit.

In a generalized sense, an electrical impulse from a transmitter is converted into a sound wave by the transducer, called a hydrophone, and sent into the water. When the wave strikes something such as a fish, it is reflected back and displays size, composition and shape of the object. The exact extent of what can be discerned depends on the frequency and power of the pulse transmitted. The signal is quickly amplified and sent to the display. Knowing the speed of sound is 4921 ft/s (1500 m/s) in seawater and 4800 ft/s (1463 m/s) in freshwater (typical values used by commercial fish finders) the distance to the object which reflected the wave can be determined. The process can be repeated up to 40 times per second and eventually results of the bottom of the ocean being displayed versus time (the fathometer function eventually spawning the sporting use of fishfinding). Note: This discussion of the propagation of sound in water is simplified; speed of sound in water depends on the temperature, salinity and ambient pressure (depth). This follows approximately this formula:

c=1448.6+4.618T−0.0523T²+1.25*(S−35)+0.017D

where
c=sound speed (m/s)
T=temperature (degrees Celsius)
S=salinity (pro mille)
D=depth
   This will give variations in speed through the water column.

Most sonar units transmit at or near the best echo frequency of the transducer (the best transmit/receive frequency). The best echo frequency generally is somewhere between the resonance and anti resonance of the transducer. Sonar units as manufactured today pick a transmitter frequency based on the median transducer echo frequency. Transducers generally have a tolerance on their echo frequency of ±4% to ±6%. The inherent±tolerance on the transducers echo frequency creates a mismatch between the fixed frequency circuit of the transmitter and the particular transducers echo frequency.

The advantage to having a sonar unit tuned to its specific transducer is the return echoes are received at maximum amplitude. This helps reduce the needed gain for a given return thereby reducing the noise levels and improving the rejection of interference from other sonar units operating nearby.

It would be desirable to: make sonar units with transmitters which can transmit at or near the best echo frequency of the transducer; reduce the amount of gain for a return; reduce the noise levels in a signal; and improve the rejection of interference from sonar units operating nearby.

### SUMMARY OF THE INVENTION

In some embodiments, a sonar system may include one or more of the following features: (a) a microcontroller electronically coupled to a receiver, (b) a transmitter electronically coupled to the microcontroller and the receiver, (c) a transducer electronically coupled the transmitter and the receiver, the transmit frequency of the transmitter being auto tuned to a best echo frequency of the transducer, (d) a display electronically coupled to the microcontroller, and (e) a keyboard electronically coupled to the microcontroller.

In some embodiments, an auto tune sonar system circuit may include one or more of the following features: (a) a microcontroller electronically coupled to a receiver, (b) a transmitter electronically coupled to the microcontroller and the receiver, and (c) a sonar transducer electronically coupled to the transmitter and the receiver, the transmit frequency of the transmitter being auto tuned to a best echo frequency of the sonar transducer.

In some embodiments, a method of auto tuning a sonar system may include one or more of the following steps: (a) determining a best echo frequency of a sonar transducer, (b) adjusting the transmit frequency to match the best echo frequency, (c) transmitting the transmit frequency, (d) transmitting a sound wave through the transducer, (f) receiving a reflected sound wave at the transducer, (e) converting the reflected sound to a received frequency and sending it to a receiver, (f) amplifying and filtering the received frequency, and (g) adjusting a bandpass filter center frequency based upon the transducers best echo frequency.

### DESCRIPTION OF DRAWINGS

FIG. 1 shows a block diagram of a sonar system in an embodiment of the present invention;

FIG. 2 shows an upper level block diagram schematic of an auto tune circuit in an embodiment of the present invention; and

FIG. 3 shows a flow process diagram of an auto tune program in an embodiment of the present invention.

### DESCRIPTION OF PREFERRED EMBODIMENT

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Embodiments of the present invention provide for tuning a transmitter to a transducer to change the transmitter's frequency to match the transducers. This could be accomplished by software in a microcontroller controlling a transmitter. The software could vary the transmit frequency while measuring the near field response of the transducer. The measurement could be taken anywhere in the signal chain as it goes through the various receiver blocks. In the proposed embodiments, the signal can be taken at the detector level and as such the receiver's filter would need to change in conjunction with the transmit frequency for proper measurement results. In another embodiment, the measurement could be taken before the receiver's filter, thus allowing the transmit frequency to be varied without concern for the receiver's filter. In this embodiment, the best fit transmit frequency would be determined and then the receiver's filter would need to be changed so its center frequency matched the transmit frequency. Another possibility would be to design the receiver filter's pass band to be wide enough to accommodate the entire band of possible transmit frequencies. In all of the above cases the receiver's filter would need to pass the required transmit frequency without attenuation in order for the auto tune process to be effective.

The auto tune function which can be controlled by a microcontroller can be run in a continual/recurring manner under software control or can be set in motion via a user interface (key pad button). In the user controlled method the auto tune could be invoked by the end user (retail customer) or implemented in production as a one time tuning function with the optimal tuned transmit frequency stored permanently in EEPROM.

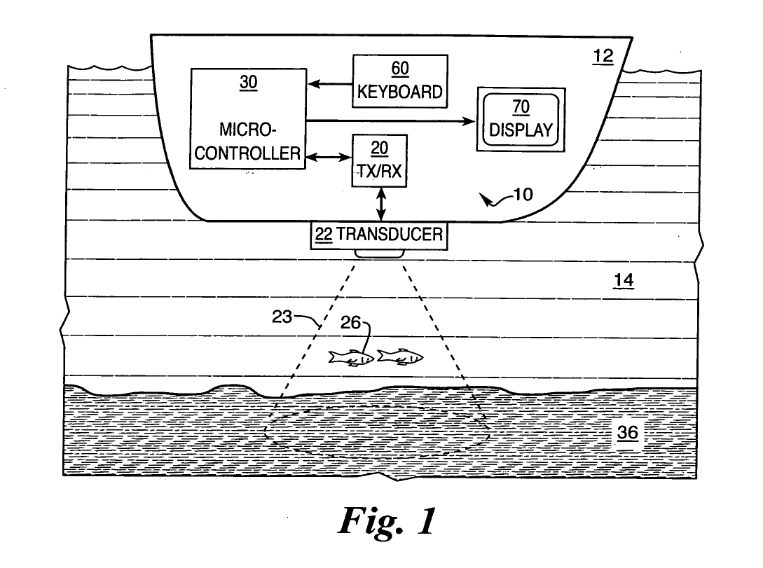

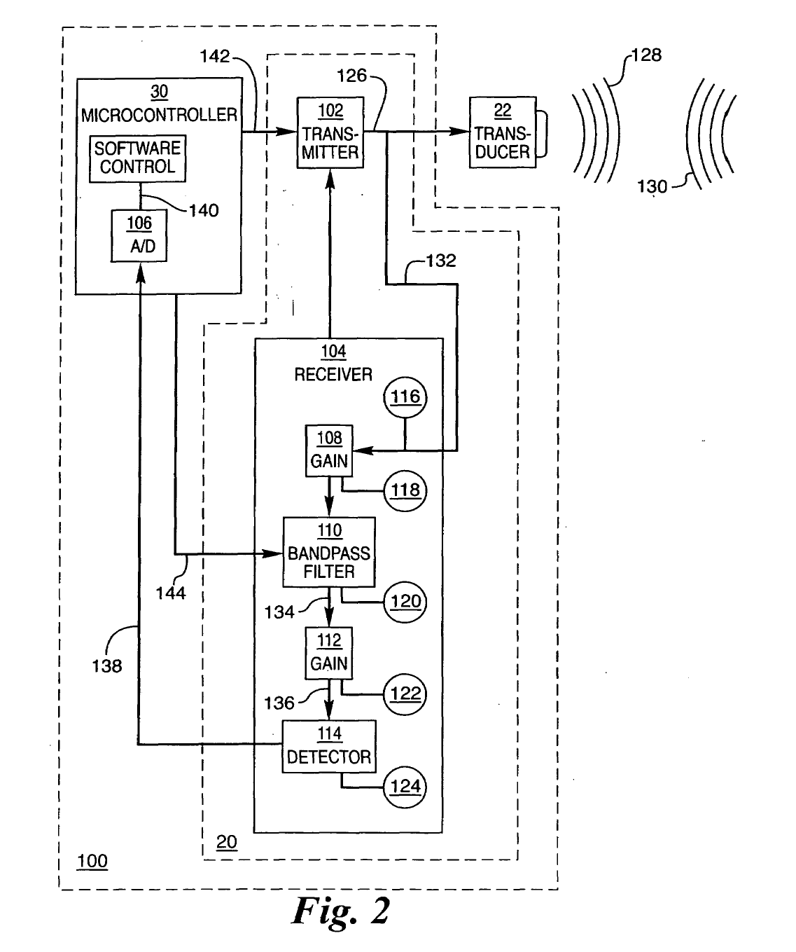

With reference to FIG. 1, a highly simplified block diagram of a sonar system is shown disposed in a boat 12 in a body of water 14. Sonar system 10 includes input device 60 by which control information and modes can be inputted to microcontroller 30. In response thereto, microcontroller 30 controls the operation of the transmitter portion of transmitter/receiver (TX/RX) 20 which produces a drive signal to control transducer 22. For example, the drive signal may be at a frequency of 200 KHz with pulse widths between 50 and 500 micro seconds.

In conventional manner, electromechanical transducer 22 is mounted to the underside of the boat 12. Transducer 22 converts the electrical drive signal from the transmitter portion of TX/RX 20 into sound waves transmitted into the body of water 14 which may, for example, be a lake or ocean. The sound waves or energy is generally transmitted in a radiation pattern axi-symmetrical. The radiated energy generally decreases away from the center or centerline of the pattern to form a beam 23 generally conically shaped. For example, the radiated energy may decrease to −3 dB which represents the 50% power point at an angle of 8 degrees on either side of the centerline. For this example, the effective beam angle of coverage or beamwidth of the transducer 22 would be 16 degrees between the −3 dB points.

The transmitted sound waves reflect back to transducer 22 from any discontinuities or obstructions in water 14, and, in any event, from the bottom 36 of the body of water 14. For example, reflections or echoes can be received from fish 26 or schools of fish. Transducer 22 generates electrical signals in accordance with the received echoes, and the electrical signals are coupled to and processed in conventional manner in the receiver portion of TX/RX 20. The output of the receiver portion of TX/RX 20 is coupled to microcontroller 30 which converts the output into electrical data representative of an echo display image of the received echoes. For example, in what is referred to as an A-scope display, an echo display image of real time echoes is arranged in a triangular cross-section corresponding to the conical beam of transducer 22. The display image is coupled to display 70.

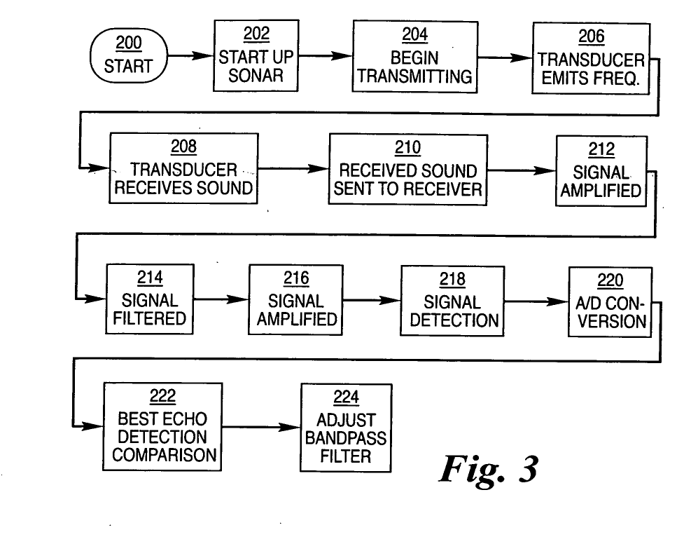

With reference to FIG. 2, an upper level block diagram schematic of an auto tune circuit in an embodiment of the present invention is shown. Auto tune circuit 100 can have a transducer 22, transceiver 20 with transmitter 102 and receiver 104, and microcontroller 30. Microcontroller 30 can have an A/D (analog to digital) converter 106. Receiver 104 is shown with an amplifier 108, bandpass filter 110, amplifier 112, and detector 114.

Microcontroller 30 is electronically coupled to transmitter 102. Microcontroller 30 can vary transmit frequency signal 142 to transmitter 102. Microcontroller 30 is also electronically coupled to receiver 104 and more specifically to bandpass filter 110. Microcontroller 30 can send a digital filter control signal 144 to bandpass filter 110. Digital filter control signal 144 adjusts the center frequency of bandpass filter 110. This operation is discussed in more detail below. Microcontroller 30 also receives detected level 138 from receiver 104. Detected level 138 informs microcontroller 30 what is the current detector level is for the particular transmit frequency.

Transmitter 102 is electronically coupled to transducer 22. Transmitter 102 sends transmit frequency 126 to transducer 22. Transducer 22 then converts this frequency to sound and transmits sound waves 128. Transmitter 102 is also electronically coupled to receiver 104.

Receiver 104 is electronically coupled to transducer 22, specifically amplifier 108 is coupled to transducer 22. Transducer 22 sends received frequency 132 to amplifier 108 where the signal is amplified for processing throughout the receiver.

As stated above, embodiments of the present invention disclose modifying the transmitter's frequency to match the transducer's frequency. Program 200, discussed in detail below, could be used to determine the transducer's best echo frequency. Program 200 would be able to modify the transmitter's frequency by measuring the near field response of transducer 22 at any one of a plurality of measurement points 116, 118, 120, 122 and 124. The measurement could be taken anywhere in the signal chain as it goes through various receiver blocks 108, 110, 112 and 114.

In one embodiment, a measurement is taken at detector 114 measurement point 124. In this embodiment, bandpass filter 110 would need to be modified so the bandpass frequencies being passed were the frequencies being transmitted and received and ensure proper measurement results.

In another embodiment, a measurement could be taken before bandpass filter 110 at measurement point 118, thus allowing the transmit frequency to be varied without concern for bandpass frequencies of bandpass filter 110. In this embodiment, it would be helpful for a best fit transmit frequency to be predetermined and then bandpass filter 110 could be synched so its center frequency matched the transmit frequency.

In another embodiment, the bandpass frequencies are set wide enough to accommodate the entire band of possible transmit frequencies. In all of the above embodiments bandpass filter 110 would need to pass the required transmit frequency without attenuation in order for the auto tune process to be effective.

The auto tune function which is controlled by microcontroller 30 can be run in a continual/recurring manner under program 200 or can be set in motion via a user interface (key pad button). In the user controlled method the auto tune could be invoked by the end user (retail customer) or implemented in production as a one time tuning function with the optimal tuned transmit frequency stored permanently in EEPROM.

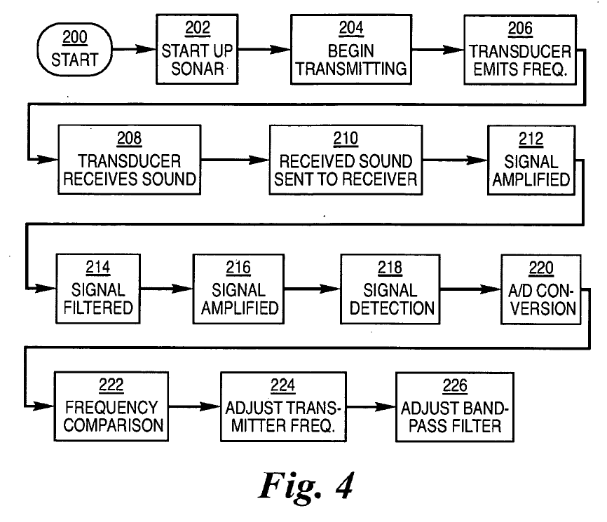

With reference to FIG. 3, a flow process diagram of an auto tune program in an embodiment of the present invention is shown. At state 202, sonar system 10 could be powered on or started up by a user. Upon power up transmitter 102 could begin to transmit a transmit frequency 142 to transducer 22 at state 204. Hopefully transmit frequency 142 has been well chosen and is very close to the best echo frequency of transducer 22. When transducer 22 receives transmitted frequency 126 from transmitter 102, transducer 22 converts the frequency to sound waves 128 and begins directing the sound into water 14 at state 206. When reflected sound wave 130 is reflected back, reflected sound 130 is converted to a received frequency 132 at state 208.

Received sound frequency 132 is sent to receiver 104 and specifically to amplifier 108 at state 210. Amplifier 108 increases the amplitude of frequency 132 before being inputted to bandpass filter 110 at state 212. At state 214 bandpass filter 110 suppresses all frequencies above and below a predetermined frequency range. Filtered signal 134 is then amplified again in amplifier 112 at state 216. Amplified signal 136 is then passed through detector 114 which converts the AC signal level to a DC signal level 136 at state 218. Detected level 138 is then sent to A/D converter 106 where detected level 138 is converted from an analog signal to a digital signal 140 at state 220. Microcontroller 30 then uses program 200 to vary transmit signal 142 over the transducer's best echo tolerance range until an optimum or best echo frequency signal is determined by program 200 in microcontroller 30 at state 222.

In one embodiment, a digital filter control signal 144 is sent to bandpass filter 110 at optional state 224. Digital filter control signal 144 adjusts the center frequency of bandpass filter 110 to adjusted transmit frequency 126. This ensures bandpass filter 110 passes all necessary frequencies of reflected sound wave 130.

It is of note state 218 can move up or down the flowchart of FIG. 3 depending on where detected level 138 is obtained from. As discussed above, detected level 138 could be taken from measurement points 116, 118, 120 or 124 all depending on the configuration of the system.

Thus, embodiments of the AUTO TUNE SONAR SYSTEM are disclosed. One skilled in the art will appreciate the present teachings can be practiced with embodiments other than those disclosed. The disclosed embodiments are presented for purposes of illustration and not limitation, and the present teachings are limited only by the following claims.

1. A sonar system for fish finding, comprising:
a microcontroller electronically coupled to a receiver;
a keyboard electronically coupled to the microcontroller;
a transmitter electronically coupled to the microcontroller and the receiver; and
a transducer electronically coupled the transmitter and the receiver, the transmit frequency of the transmitter being auto tuned to a best echo frequency of the transducer.

2. The sonar system of claim 1, further comprising a display electronically coupled to the microcontroller.

3. (canceled)

4. The sonar system of claim 1, wherein the transmit frequency of the transmitter is controlled by the microcontroller.

5. The sonar system of claim 1, wherein the microcontroller receives a detected level from the receiver.

6. The sonar system of claim 5, wherein the detected level is the best echo frequency of the transducer.

7. The sonar system of claim 6, wherein the detected level can be taken at multiple locations at the receiver.

8. An auto tune sonar system circuit for fish finding, comprising:
a microcontroller electronically coupled to a receiver;
a transmitter electronically coupled to the microcontroller and the receiver; and
a sonar transducer electronically coupled the transmitter and the receiver, the transmit frequency of the transmitter being auto tuned to a best echo frequency of the sonar transducer.

9. The auto tune circuit of claim 8, wherein the sonar transducer receives a reflected wave and converts it to a received frequency sent to the receiver.

10. The auto tune circuit of claim 9, wherein the receiver amplifies and filters the received frequency to produce a detected level.

11. The auto tune circuit of claim 10, wherein the receiver sends the detected level to an A/D converter.

12. The auto tune circuit of claim 11, wherein the microcontroller takes a digital signal from the A/D converter and determines a best echo frequency based on varying a transmit frequency and comparing detected levels.

13. A method of auto tuning a sonar system for fish finding, comprising the steps of:
determining a best echo frequency of a sonar transducer; and
adjusting the transmit frequency to match the best echo frequency.

14. The method of claim 13, further comprising transmitting the transmit frequency.

15. The method of claim 14, further comprising transmitting a sound wave through the transducer.

16. The method of claim 15, further comprising receiving a reflected sound wave at the transducer.

17. The method of claim 16, further comprising the step of converting the reflected sound to a received frequency and sending it to a receiver.

18. The method of claim 17, further comprising the step of amplifying and filtering the received frequency.

19. The method of claim 18, further comprising adjusting a bandpass filter center frequency based upon the transducer's best echo frequency.
